(19) United States
(12) Patent Application Publication
(10) Pub. No.: US 2004/0050042 A1
(43) Pub. Date: Mar. 18, 2004

(54) Emergercy energy release for hydraulic energy storage systems

(76) Inventor: Hugh Ivo Frazer, Missabotti (AU)

Correspondence Address: James J DeCarlo, Stroock & Stroock & Lavan, 180 Maiden Lane, New York, NY, 10038, US

(21) Appl. No.: 10/432,882

(22) PCT Filed: Nov. 28, 2001
(86) PCT No.: PCT/IB01/02784

(30) Foreign Application Priority Data
Nov. 28, 2000 (AU) PR 1704

(51) Int. Cl. F16D 31/02

(52) U.S. Cl. 60/413

(57) ABSTRACT

A method for the release of energy in storage hydraulic energy propulsion systems having hydro-pneumatic accumulators used in vehicles and in hydraulic hybrid vehicles. Novel pressure-release valves and valve systems for the sensing of gas and fluid (liquid) pressures and for detecting malfunctions or pressure variations within an energy storage system are disclosed.

### BACKGROUND OF THE INVENTION

(i) Field of the Invention

This invention relates to methods for the release of stored energy in hydraulic energy storage systems by means of relieving valves and valve systems and, more particularly, relates to pressure-release valves and valve systems for release of stored energy in hydraulic energy storage systems, such as used fluid drive systems in vehicles.

(ii) Description of the Related Art

Vehicles with hydraulic energy storage systems equipped have the ability to store kinetic energy while braking, rather than dissipate it through the brakes, and then restore it for subsequent acceleration. Such vehicles are commonly called “Hydraulic Hybrid” when the vehicle prime mover also contributes to the energy store, or “Stored Hydraulic Energy Propulsion” (SHEP) when only the vehicle energy is stored. This application refers to SHEP storage, but the inventions disclosed herein may be equally applicable to hydraulic hybrid vehicles.

The improvements of the present invention apply to hydro-pneumatic accumulators that are normally used to store energy in SHEP vehicles, and to the associated hydraulic circuitry. In line with industry practice, the term “fluid” as used in this application refers to hydraulic fluid, typically a liquid such as a specially formulated mineral oil. The term “gas” refers to the gas used to precharge a hydro-pneumatic accumulator, typically being dry nitrogen.

The performance and fuel economy of a vehicle, particularly one subject to frequent stops and starts, can be improved by storing the vehicle kinetic energy during deceleration and then restoring it, less any losses that may occur, during subsequent acceleration. SHEP systems have a hydraulic pump/motor (P/M) that can be connected to the drive train of the vehicle, so that the vehicle can be decelerated by pumping high pressure hydraulic fluid into a hydro-pneumatic accumulator. Subsequent acceleration can, at least in part, be achieved by using the stored kinetic energy to drive the P/M as a motor. Hydraulic hybrid systems have this same capability with the addition of a hydraulic pump driven by the vehicle engine. This provides a more flexible system at the cost of increased complexity. Importantly it provides for still further improvements in fuel economy by optimising engine usage.

Hydraulic hybrid and SHEP vehicles have been the subject of many patents and technical papers. U.S. Pat. No. 3,903,696 shows a basic SHEP system, with U.S. Pat. No. 4,760,697 being a more complex version, and U.S. Pat. No. 4,242,922 describing the basics of a hydraulic hybrid, all incorporated herein by reference.

Published technical papers cover the use of SHEP and hybrid systems in automobiles, buses, garbage trucks, trains and other vehicles are typified by the following papers: Mechanical power regeneration system; “Simulation of a Hydraulic Hybrid Vehicle Power Train”, ASME-Paper n 73-ICT-50, Sep. 23-27 1973; “Practical Considerations for Energy-Storage Motor Vehicles”, published by ASME, New York, N.Y., U.S.A. 1981; and “Studies of an Accumulator Energy-Storage Automobile Design with a Single Pump/Motor Unit, SAE Paper 851677 1985.

### SUMMARY OF THE INVENTION

In its broad aspect, the method of the invention for releasing a compressed gas in a hydraulic energy storage system having a high pressure accumulator or compensated high pressure accumulator with a low pressure accumulator containing low pressure gas and fluid, and having sensing means in communication with the low pressure gas and fluid and operatively connected to a pressure-release valve, for controlled venting of gas to the atmosphere through the pressure-release valve, comprises sensing the pressure of the low pressure gas or fluid within a predetermined pressure range and opening the pressure-release valve upon sensing a gas or fluid pressure below or above the predetermined pressure range.

The pressure-release system of the invention, in its broad aspect, for use in a dual accumulator hydraulic energy storage system having a low pressure accumulator, a high-pressure accumulator and a pump/motor in fluid communication with the high pressure accumulator and the low pressure accumulator, comprising a first pressure-release valve having a high pressure gas port in communication with the high pressure accumulator and a low pressure gas port in communication with the low pressure accumulator for venting high pressure gas from the high pressure accumulator to the atmosphere when low pressure gas exceeds a predetermined high pressure, said first pressure-release valve having latching means for maintaining the valve open to continue venting of high pressure gas once venting is initiated, and a second pressure-release valve having a high pressure gas port in communication with the high pressure accumulator and a low pressure gas port in communication with the low pressure accumulator for venting high pressure gas to the atmosphere when the low pressure gas falls below a predetermined low pressure, and a check valve communicating the low pressure accumulator to the high pressure accumulator for venting low pressure gas through the high pressure port of the first valve when the high pressure gas pressure falls below the low pressure gas pressure. The pressure-release system may additionally comprise a manual valve in communication with the low pressure accumulator and the low pressure gas port of the second pressure-release valve for venting low pressure gas to atmosphere, and an orifice disposed between the low pressure accumulator and the manual valve to cause a pressure drop at the low pressure gas port of the second pressure-release valve upon opening of the manual valve and release of low pressure gas for simultaneous venting of high pressure gas to atmosphere from the second pressure-release valve.

A variation of the pressure-release system may comprise a solenoid-actuated vent valve in communication with the high pressure accumulator for controlled discharge of high pressure gas therefrom, a pressure transducer operatively connected to the low pressure conduit and to the solenoid-actuated vent valve and a pressure transducer operatively connected to the high pressure conduit and to the solenoid-actuated vent valve for sensing pressure in the low pressure and high pressure conduits for actuating the solenoid-actuated vent valve for discharging the high pressure gas to atmosphere upon sensing a fluid pressure below or above a predetermined range, and a check valve communicating the low pressure accumulator to the high pressure accumulator for venting low pressure gas from the low pressure accumulator through the solenoid-actuated vent valve when the high pressure gas falls below the low pressure gas pressure.

The pressure-release system of the invention for use in a compensated accumulator system having a high pressure compensated accumulator, a low pressure accumulator and a pump/motor in fluid communication with the high pressure compensated accumulator and the low pressure accumulator, comprising a vent valve in communication with the high pressure compensated accumulator for discharge of high pressure gas therefrom, said vent valve having a low pressure gas or fluid port in communication with a low pressure gas or fluid source for maintaining the first vent valve normally closed over a predetermined pressure range and sensing means operatively connected to the vent valve for sensing the pressure of the low pressure gas or fluid source and actuating the vent valve for discharging the high pressure gas to atmosphere upon sensing a gas or fluid pressure below or above the predetermined range.

The pressure-release system may additionally comprise a small low pressure accumulator in fluid communication with the low pressure accumulator, said small low pressure accumulator having a low pressure gas outlet in communication with the vent valve for maintaining the vent valve closed over a predetermined low pressure fluid pressure range, a first pressure-release valve in communication with the low pressure gas outlet through an orifice and with the low pressure accumulator for opening when low pressure fluid exceeds the predetermined pressure range, said first pressure-release valve having latching means for maintaining the valve open once venting is initiated, and a second pressure-release valve in communication with the low pressure gas outlet through the orifice and with the low pressure accumulator for opening when the low pressure fluid drops below the predetermined pressure range, whereby the low pressure gas pressure drops permit the vent valve to open to vent high pressure gas to atmosphere.

A pressure-release valve of the invention comprises a valve body having a cylindrical chamber therein said cylindrical chamber having an enlarged diameter at one end defining an enlarged co-axial chamber, said chamber having an axial opening communicating with a high pressure port at one end of the valve body, said axial opening having an annular chamber formed therein, an elongated plunger slidably mounted for reciprocal axial travel in the cylindrical chamber, the enlarged chamber and the axial opening, said plunger having a sealing poppet at one end and an annular recess in proximity to the sealing poppet defining a land between the sealing poppet and annular recess, sealing means formed in the axial opening between the cylindrical chamber and the axial opening annular chamber for slidably receiving the plunger land in sealing engagement, a pair of opposed, spaced-apart pistons slidably mounted on the plunger concentric therewith, one of said pistons slidable in the cylindrical chamber and the other piston slidable in the enlarged chamber, detent means formed on the plunger for engaging the pistons for advancing the sealing poppet, means for urging the pistons axially apart, a valve seat adjacent the high pressure port for receiving the sealing poppet in a normally-closed position, said cylindrical chamber having a low pressure port in communication with the enlarged cylindrical chamber, and an atmospheric port in communication with the annular chamber and with the cylindrical chamber between the pair of opposed pistons, whereby an increase in low pressure gas or a decrease in low pressure gas will axially extend the pistons and the plunger land to clear the axial opening sealing means to rapidly actuate the sealing poppet clear of the valve seat to vent high pressure and low pressure gas to atmosphere.

### BRIEF DESCRIPTION OF THE DRAWINGS

The pressure-release valves and valve systems of the invention will now be described with reference to the accompanying drawings, in which:

FIG. 1 is a schematic illustration of a prior art SHEP system with two accumulators;

FIG. 2 is a schematic illustration of a prior art SHEP system with compensated accumulator;

FIG. 3 is a schematic illustration of a release of stored energy using fluid logic;

FIG. 4 is a schematic illustration of a release of stored energy using computer or electrical logic;

FIG. 5 is a schematic illustration of a release of stored energy with a compensated accumulator;

FIG. 6 is a longitudinal section of a high low pressure activated energy release valve;

FIG. 7 is a longitudinal section of a low low pressure activated energy release valve; and

FIG. 8 is a longitudinal section of an energy release valve having a blow-out disk.

### DESCRIPTION OF THE PREFERRED EMBODIMENTS

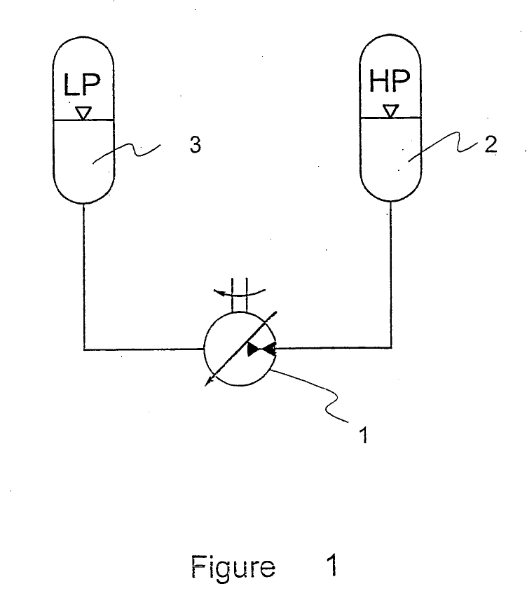

FIG. 1 shows a schematic of the basic elements of a prior art SHEP system, by way of example, consisting of a pump/motor (P/M) unit 10 connected to the drive train of the vehicle, not shown, so that the P/M rotation is coupled to the vehicle motion. Energy is stored in the high pressure (HP) accumulator 12. The BP accumulator typically has a pre-charge pressure of about 150 bar and a maximum pressure of up to 406 bar. Because the P/M unit is typically a high speed axial piston unit, it requires a charge pressure, typically about 10 bar, at its inlet when pumping if cavitation is to be avoided at higher speeds. This is provided by low pressure (LP) accumulator 13. More detailed circuits using either overcentre or non-overcentre P/M units are shown in the references.

As the vehicle is braked, the P/M acts as pump transferring fluid from the LP accumulator 13 to the HP accumulator 12. Fluid entering the HP accumulator 12 will compress the gas therein, thus causing the pressure to rise. At the same time fluid must leave the low pressure accumulator, urged by the LP gas pressure, so that the LP pressure must fall. The amount of fall depends on the relative sizes of the two accumulators. Normally the LP accumulator will be larger than the HP, so that the LP pressure range is less than on the HP side.

When the vehicle is subsequently accelerated, the P/M acts as a motor, taking high pressure fluid from the BP accumulator 12 and discharging it to the LP accumulator 13, with a fall in HP pressure and an increase in LP pressure. Both BP and LP 15 accumulator pressures thus fluctuate over a design range of pressures as the vehicle is braked and accelerated. The accumulators can be of the bladder or piston type.

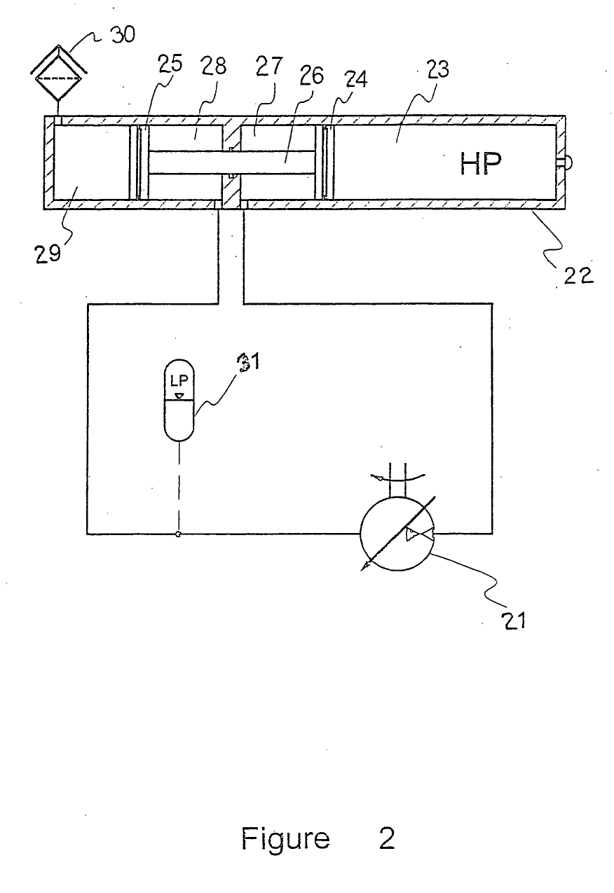

FIG. 2 shows a schematic of a similar SHEP prior art system using a compensated accumulator, which effectively combines high and low pressure into one assembly so that the flow into the high pressure side is off-set by the flow from the low pressure side. Essentially the system consists of two piston accumulators placed together with the pistons joined in axial alignment with a connecting rod. U.S. Pat. No. 2,721,446 and U.S. Pat. No. 3,918,498, both incorporated herein by reference, describe such a device. In its simplest form it obviates the need for the LP accumulator as flow into the HP accumulator is fully off-set by flow from the LP piston.

The P/M unit 21 is connected to the compensated accumulator 22. The compensated accumulator 22 consists of a housing construction enclosing a pre-charged gas filled high pressure chamber 23, with a reciprocally-moving assembly consisting of a HP piston 24, LP piston 25 and connecting rod 26, all with seals as shown. Chamber 27 to the left of the HP piston 24, as viewed in FIG. 2, is connected to the SHEP HP side, while chamber 28 to the right of the LP piston 25, is connected to the SHEP LP side. Chamber 29 to the left of the LP piston 25, is connected to atmosphere through filter breather 30.

Flow of HP fluid into the accumulator chamber 27 will cause the piston assembly to move to the right, displacing an equal volume of fluid out of the LP port, and drawing air in through the breather 30. Conversely, flow of HP fluid out of the accumulator chamber 27 will cause the piston assembly to move to the left, drawing an equal volume of LP fluid in, and pushing air out through the breather 30.

A small LP accumulator 31 is required to ensure that a suitable charge pressure is maintained at the P/M inlet and to compensate for volume variations due to changing system temperature and other factors. There is no flow in and out of this accumulator during a normal deceleration and acceleration cycle. In contrast to the equivalent system illustrated in FIG. 1, there is no variation of LP as the accumulator is charged and discharged.

FIG. 2, as described above, shows a fully compensated accumulator where the LP and HP flows are equal. It is sometimes an advantage to use a partially compensated accumulator, where the areas of the pistons 21 and 25 are not equal, so that the LP and HP flows are unequal. There is then some flow into and out of the LP accumulator 31, which can be used for circulation purposes. There will then be some variation in LP as the accumulator is charged and discharged, depending on the degree of compensation and the size of the LP accumulator.

Any failure of the energy storage system can be expected to lead to a loss of function of the system, so the system must be designed to be reliable under its normal operating conditions. This is not a concern of this application, which considers the safety and pollution hazards that may arise from an accident; such as caused by a material or assembly fault, by improper service procedures, by damage from a vehicle collision, by a vehicle fire, or by any other cause.

The energy in a hydraulic storage system is stored as compressed gas. The BP accumulator will normally have a precharge of about 150 bar and a maximum pressure of up to 400 bar when the storage is at maximum capacity.

Taking a large passenger automobile, such as a sports utility vehicle, as an example, the precharge gas volume can be 30 litres or more. This is compressed to about half its volume under fully charged conditions. If this gas is accidentally suddenly discharged it will expand to about 1500 litres, at a gas temperature of about −180° C., dissipating about 1000 kJ of energy.

This is not a lot of energy in the context of total vehicle hazard, being roughly equivalent to 30 ml of gasoline, so discharge of the high pressure gas being also inert need not present a severe hazard providing that the means of discharge is sensibly controlled.

The system will also contain about 25 litres of hydraulic fluid. This can be a specially formulated mineral oil, or a fire-resistant and biodegradable fluid. Under some circumstances a failure of the energy storage system can lead to a severe fluid leak propelled by the stored gas energy. This possibility represents a much more serious hazard than discharge of the gas alone.

If the storage is empty, most of the fluid will be in the LP part of the system. In the case of a system using two accumulators, as typified in FIG. 1, an external leak can lead to this fluid being discharged propelled by the LP gas. In the example system this would represent a fluid loss of about 20 litres.

In the case of a system using a compensated accumulator, as typified in FIG. 2, the only leakage propelled by the LP gas is from the much smaller LP accumulator 31. In the example system this would represent a leakage of about 2 litres, being an advantage of the compensated accumulator.

If the storage is full, most of the fluid will be in the HP accumulator. In either case, typified by FIG. 1 or FIG. 2, an external LP leak would be small, but an external HP leak could lead to a discharge of about 15 litres propelled by the high pressure gas representing a significant hazard.

The majority of the possible failure conditions involving the stored energy are listed below, with components on their hazard potential, and will be referred to by the Case letters listed.

A. Excessive HP gas pressure, due perhaps to accidental over-charging or high temperatures from a vehicle fire; normally handled by a safety valve or blow-out disk to provide a controlled failure mode, as is common practice with gas pressure vessels; not a serious hazard providing properly managed.

B. Excessive LP gas pressure, causes as above; normally handled as above; not a significant hazard providing properly managed. This invention incidentally provides means for detection.

C. Rapid loss of HP gas directly to atmosphere, as discussed above; not a serious hazard providing properly managed.

D. Rapid loss of LP gas directly to atmosphere; not a serious hazard.

E. Slow loss of HP gas to atmosphere; not a hazard but leads to malfunction of the system.

F. Slow loss of LP gas to atmosphere; not a hazard but leads to malfunction of the system. This invention incidentally provides means for detection.

G. Rapid external leak of HP fluid, as discussed above; presents a potentially serious hazard and needs to be minimized. This invention provides means.

H. Rapid external leak of LP fluid, also as discussed above; presents a potential hazard and needs to be minimized. This invention provides means.

I. Slow external leak of fluid; presents a nuisance rather than a severe hazard, with pollution implications if undetected. This invention provides means for detection and minimization.

J. Internal leak of HP gas into the fluid side; can lead to excessive LP fluid pressure causing failure (of a filter or heat exchanger for example) leading to external LP fluid leakage; presents a potential hazard and needs to be minimized. This invention provides means.

K. Internal leak of LP gas into the fluid side; leads to malfunction of the system rather than creating a hazard situation. This invention provides means for detection.

L. A vehicle accident or vehicle service situation where it is required to manually discharge the stored energy to minimize hazard. This invention provides means.

From this list, the most damaging situations are Cases G, H and J, with Cases I and L also requiring consideration. Cases A, B, C and D could present a hazard situation but can be managed by known appropriate methods. Cases E, F and K cause system malfunction rather than a hazard situation, but emphasize the need for the system to be designed to malfunction in a safe manner.

The present invention primarily, but not exclusively, uses variations in the LP gas or the fluid to provide the detection of a hazard situation and to implement a remedial action. The responses of the LP pressures are discussed below on a hazard case basis.

A. Excessive HP gas pressure. No effect on LP pressures.

B. Excessive LP gas pressure. High LP gas and fluid pressures.

C. Rapid loss of HP gas directly to atmosphere. Probably no immediate effect on LP pressures. Operation of the system leads to low LP fluid pressure with dual accumulator systems, as the HP accumulator will accept too much fluid within the systems control parameters.

D. Rapid loss of LP gas directly to atmosphere. Low LP pressures.

E. Slow loss of HP gas to atmosphere. Operation of the system eventually leads to low LP fluid pressure with dual accumulator systems, as explained in C above.

F. Slow loss of LP gas to atmosphere. Low LP pressures.

G. Rapid external leak of HP fluid. This can occur without effect on the LP pressures in dual accumulator systems, unless the system is being operated. LP pressures will fall within compensated accumulator systems, as is explained later.

H. Rapid external leak of LP fluid. Low LP pressures.

I. Slow external leak of fluid. Low LP pressures.

J. Internal leak of HP gas into the fluid side. High LP pressures, as the HP gas in the fluid expands when it reaches the LP side.

K. Internal leak of LP gas into the fluid side. Low LP pressures when the storage is charged, as the compression of the gas in the fluid as it becomes pressurized reduces the overall gas volume in the system.

L. Manual energy discharge. No effect on LP pressures.

This list shows that most hazard and malfunction conditions are accompanied by a change in the LP pressures, particularly the most crucial cases of G, H and J, although G only with compensated accumulator systems.

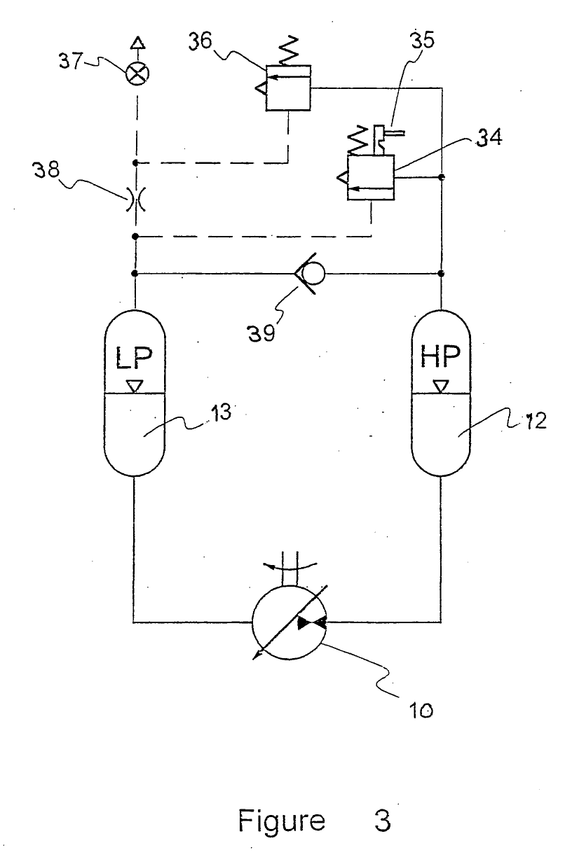

FIG. 3 shows a schematic of a dual accumulator system incorporating an embodiment of the invention to automatically vent the HP gas should the LP gas pressure exceed the normal range. Pump/motor 10, HP accumulator 12 and LP accumulator 13 are as described in FIG. 1. In normal operation, both accumulators 12 and 13 operate over a range of approximately 2:1 such as from 2500 psi when fully discharged to about 5000 psi when fully charged. LP gas pressure outside this range indicates a potential hazard situation where venting of the HP gas is required.

Two valves are shown pilot operated by the LP gas pressure. Venting valve 34 opens if the LP gas pressure becomes too high, exceeding the spring setting, with a mechanical latch 35 so that once operated it remains open. Venting valve 36 opens if the LP gas pressure becomes too low, with the valve opened by the spring on falling pilot pressure. In either case, check valve 39 vents the LP gas once the HP gas is exhausted. Manual valve 37 provides for venting of the HP and LP gas to meet the requirements of Case L. Orifice 38 causes a pressure drop as the LP gas is discharged by manual valve 37 so that venting valve 36 opens simultaneously to vent the HP gas.

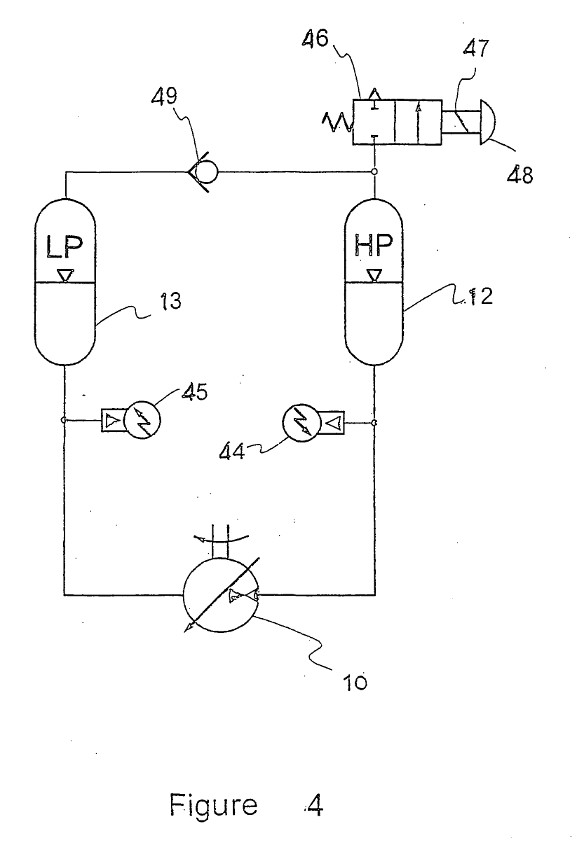

FIG. 4 illustrates an electrical analogue of the same system as illustrated in FIG. 3 with pressure transducers 44 and 45 providing the necessary input information. Each of these can consist of a number of pressure switches to provide a direct control output or comprise a plurality of analogue transducers inputting into a control computer. Either way the control opens venting valve 46 by the operation of its solenoid 47.

The venting valve is also shown with a manual over-ride 48 that meets the requirement of Case L. Check valve 49 provides for the venting of the LP gas once the HP gas is exhausted.

The electrical system can be more sophisticated than the simple system illustrated in FIG. 3. For example, it can be readily triggered by other inputs, such as from a collision sensor. It can also monitor the high pressure so that an unexpected reduction in high pressure can be identified as a Case G situation and trigger the venting of the HP gas to minimize the quantity of fluid leakage.

It can also take into account the normal fluctuations of both HP and LP pressures as the flow is transferred back and forth between the two accumulators. When the energy storage is empty, the HP is at its minimum and the LP is at its maximum, and when the energy storage is full, the HP is at its maximum and the LP at its minimum. The electrical control system can take this into account and provide a more sensitive response to LP variations by taking the HP into account. For example, taking a system where the LP varies from 10 bar with no stored energy down to 5 bar when fully charged, the acceptable low LP pressures could then vary from about 9 bar down to 4 bar before the system is vented. The simpler system of FIG. 3 would require that venting valve 35 be set to 4 bar, regardless of the state of energy charge. The limitations of FIG. 3 can be overcome by the use of venting valves that are sensitive to both the HP and the pilot LP, as will be discussed hereinbelow.

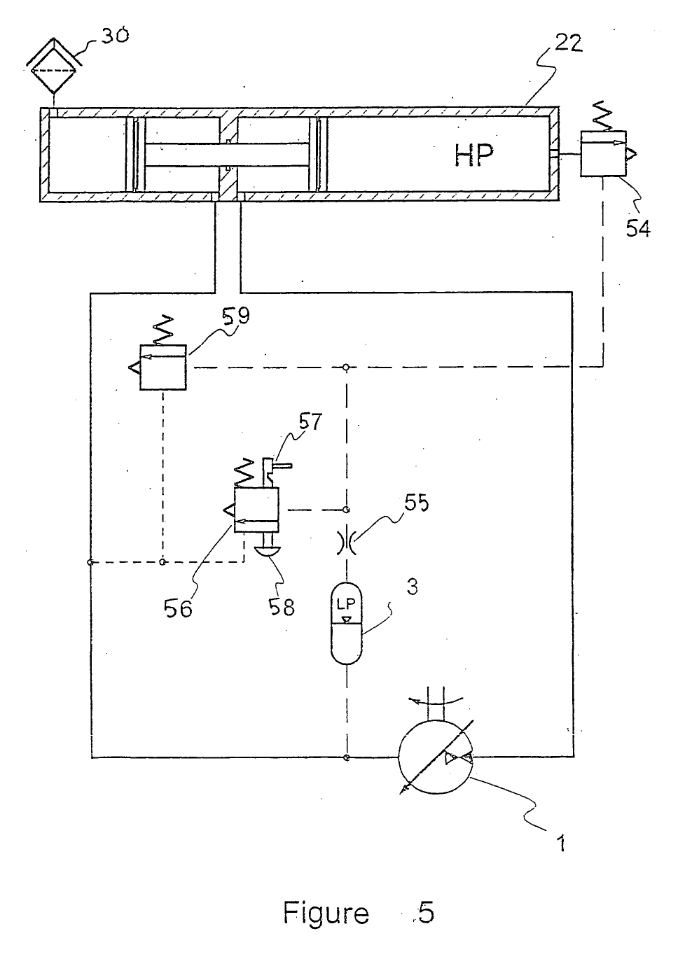

The application of vent valves to a compensated accumulator system is illustrated schematically in FIG. 5. This embodiment uses a main venting valve 54 to discharge the high pressure gas and two smaller venting valves 56 and 59 that both vent the low pressure and pilot the main venting valve. The two smaller valves are shown pilot operated by LP fluid pressure rather than gas pressure; either gas or fluid pressure could be used.

Main venting valve 54 is held closed by the LP gas pressure acting through orifice 55 until one of the smaller venting valves opens to cause a fall in the main pilot gas pressure.

Venting valve 56 opens if the LP is too high. It is then locked in the open position by mechanical latch 57. Manual operator 58 allows operation of the valve to vent both HP and LP gas to satisfy Case L. Venting valve 59 opens if the LP is too low.

This system can be set sensitively because there is nominally no variation in LP due to the action of the compensated accumulator. If a partially compensated accumulator is used, there will be some variation in LP which will reduce the possible sensitivity unless some feedback of accumulator piston position or HP pressure is introduced. Compensated accumulator systems have advantages over dual accumulator systems as previously discussed, and have an additional advantage in being sensitive to external high pressure fluid leakage, considered the most serious hazard situation.

Imagine for example that a vehicle accident occurs with impact on the energy storage system causing an external HP fluid leak. As the fluid leaks out, the HP gas will move the accumulator piston to the left to maintain the fluid at high pressure. This will cause fluid to be drawn into the LP fluid side of the accumulator, drawing fluid out of the LP accumulator 53, and causing an immediate fall in LP, triggering venting valve 59 which in turn triggers the main venting valve 54 to discharge the high pressure gas. Any further external leakage will then be under the influence of gravity, and not propelled by gas pressure, both reducing the hazard and pollution by spillage of the hydraulic fluid.

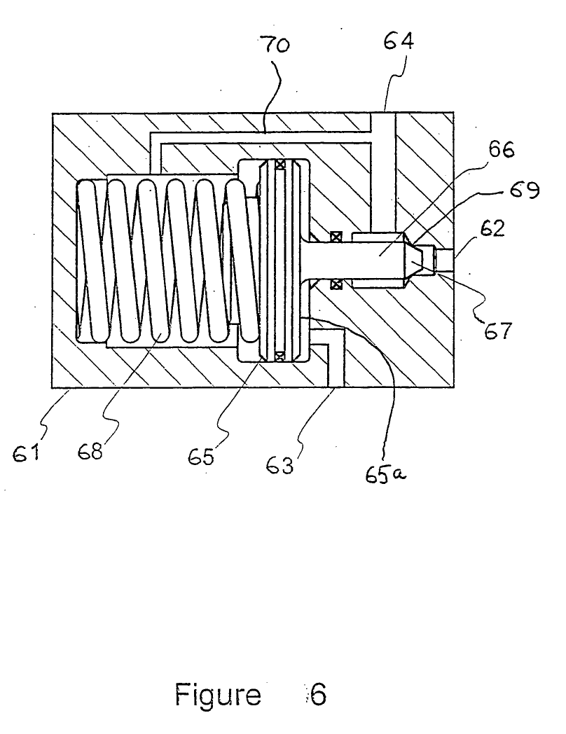

The description of the systems illustrated in FIGS. 3 and 4 discussed the benefit of venting valves that react to HP as well as LP to make allowance for the range of operating pressures in a dual or partially compensated accumulator system. FIG. 6 illustrates a valve of the invention that vents HP gas when the LP is too high, with a lower setting at higher HP values, as is desirable with a dual or partially compensated accumulator. A valve body 61 has three ports; port 62 connected to HP gas, port 63 to LP gas or fluid and port 64 to atmosphere. A valve plunger 65 consists of a sealed piston with a stem 66 ending in a sealing poppet 67 seated on valve seat 69 that seals off the HP has when the valve is in the normally closed position, as shown. The plunger is urged to the closed position by compression spring 68.

The spring chamber is connected to atmosphere at port 64 by conduit 70. The LP acts on the area 65a of the plunger piston 65 tending to open the valve. The BP gas acts on the poppet area 67 also tending to open the valve. Suitable selection of the piston area, poppet area and spring force provides the required opening characteristic of a lower LP with increasing HP.

This section illustration is diagrammatic; the HP poppet is shown oversize for clarity of illustration; the spring is not drawn to true dimension; the mechanical latch shown as latch 35 in FIG. 3 is not illustrated and may be implemented in many ways by one skilled in the art.

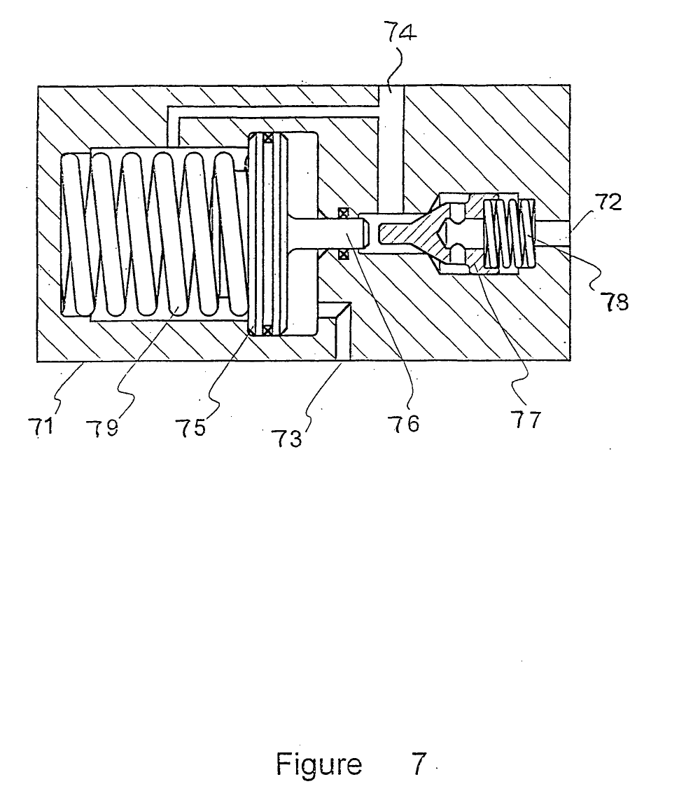

FIG. 7 illustrates another embodiment of valve that will vent HP gas when the LP is too low, with a lower setting with higher HP values, as is desirable with a dual or partially compensated accumulator. A valve body 71 has three ports; port 72 connected to HP gas, port 73 to LP gas or fluid and port 74 to atmosphere. A valve plunger 75 consists of a sealed piston with a stem 76. The HP gas is sealed by a poppet valve 77 held closed both by a compression spring 78 and by the HP gas acting on the poppet seat 80.

The plunger stem 76 is urged to push open the poppet valve 77 by main compression spring 79, resisted by the normal closing forces on the poppet itself and by the LP acting on the area of the plunger piston. Sufficient LP will hold the plunger against the spring 79 in the position shown. As the LP falls, the plunger will move to the right as depicted in FIG. 7 to engage the poppet 77. A further fall in LP will allow the spring force to also overcome the poppet closing forces and the valve will open to vent the HP gas to atmosphere.

Suitable selection of the piston area, poppet area and spring force provides the required opening characteristic of a lower LP with increasing LP. This illustration is diagrammatic; the HP poppet is shown oversize for clarity and the main spring is not drawn to true dimension.

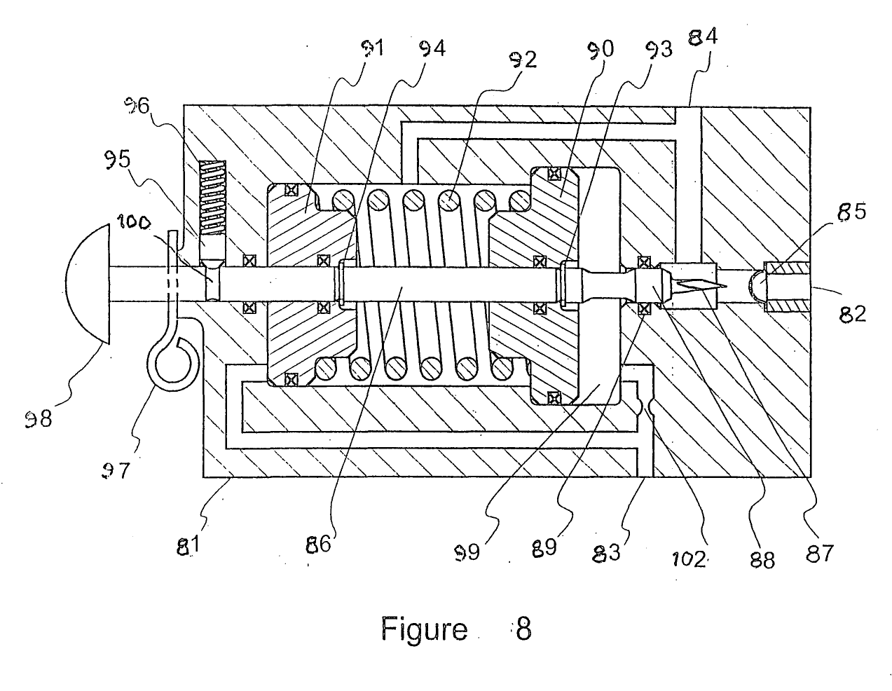

FIG. 8 shows a combined valve arrangement that meets all the specified requirements for emergency venting, other than the variable setting capabilities described with reference to FIGS. 6 and 7. A valve body 8 1 has three ports; port 82 connected to HP gas, port 83 to LP gas and port 84 to atmosphere. The HP gas is sealed off by blow-out disk 85, which also acts as a safety release should the HP gas pressure become too high.

A plunger 86 has a blade 87 that acts to puncture the blow-out disk 85 to vent the HP gas. A land 88 engages with seal 89 to prevent leakage of LP gas to atmosphere, but acts as a valve to vent LP gas with movement of the plunger, to be described. Pistons 90 and 91 move reciprocally axially within he body 81, forced apart axially by main spring 92, and can move the plunger by reacting onto retaining rings 93 and 94. A detent cam 95, urged by spring 96, engages with an annular groove 100 in plunger 86. A safety pin 97 holds the plunger in the non-activated piston illustrated in FIG. 8. A manual button 98 provides for manual operation of the venting system.

The valve is assembled with the safety pin 97 installed to prevent the main spring firing the plunger through the blow-out disk. The valve is by preference mounted directly onto the HP gas end of the accumulator to minimize the possibilities of HP gas leakage. Port 83 is connected to the LP gas system. When this system is pre-charged, piston 90 will overcome the force of the main spring and hold in the position shown. The safety pin can be removed. The plunger is held in the position shown against vibration or other external influence by the detent and by the friction of the seals acting on the plunger.

Should the LP become too high, the force acting on piston 91 will overcome the bias of the main spring 92 and move the plunger to the right as viewed in FIG. 8. As the plunger land 88 clears the ring seal 89, the LP gas in chamber 99 will be vented to atmosphere. Orifice 102 limits the inflow of LP gas so that the pressure in the chamber will rapidly fall, allowing the combined force of the main spring and the LP acting on piston 91 to fire the plunger blade 87 through the blow-out disk 85.

This action vents both the HP and LP gas and the valve remains in the vented position until—the blow-out disk is replaced and the safety pin reinstalled; the combined action of the LP valve formed by the land 88 and its associated seal 89 with the orifice 102 obviates the need for a mechanical latch as shown in other figures.

Should the LP become too low, the force acting on piston 90 will no longer be enough to resist the force of the main spring 92 and the plunger will move to the right, initiating the same sequence of events as described in the previous paragraphs leading to the firing of the plunger blade 87 through the blow-out disk 85.

Pressing the manual button 98 to overcome the resistance of the detent 95 and the seals will cause the plunger to move to the right, again with the same sequence of the events to rupture the blow-out disk 85.

The safety pin can be replaced if it is desired to discharge the LP for service reasons, but this obviously disables the safety system so the pin must be removed again before the storage system is put back into operation.

The blow-out disk can be replaced by the poppet assembly of FIG. 7 to provide a system that can be reset without disassembly and replacement of parts. The safety pin is then no longer required, providing that the LP is precharged before the HP.

A redesign of the poppet to provide for some travel before opening would also provide the variable setting characteristic of the low LP as described with FIG. 7. The variable setting of FIG. 6 with high LP cannot be as readily achieved, but this is not as important because high LP is only caused by HP gas leaking into the fluid, which does not present a hazard until the LP is high enough to cause a component failure; the fixed high LP setting can be well within the capability of all the low pressure components.

It will be understood, of course that modifications can be made in the embodiment of the invention illustrated and described herein without departing from the scope and purview of the invention as defined by the appended claims.

1. A pressure-release valve comprising a valve body having a cylindrical chamber therein, a piston having a front side and a rear side with an axial stem extending from the front side terminating in a sealing poppet at its terminal end reciprocally mounted in the cylindrical chamber, said chamber having an axial opening communicating with a high pressure port at one end of the valve body, said axial opening having an annular chamber with a, valve seat adjacent the end of the valve body for receiving the sealing poppet to form a poppet valve, a compressing spring for urging the piston and the sealing poppet to an extended, normally-closed position against the valve seat for sealing the high pressure port, said cylindrical chamber having a low pressure port in communication with the cylindrical chamber and the front side of the piston, and an atmospheric port in communication with the annular chamber and with the cylindrical chamber and the rear side of the piston, whereby an increase ii low pressure gas will axially retract the piston to open the poppet valve for communicating the high pressure port to the atmosphere.

2. A pressure-release valve comprising a valve body having a cylindrical chamber therein, a piston having a front side and a rear side with an axial stem extending from the front side thereof, reciprocally mounted in the cylindrical chamber, a compression spring for urging the piston and axial stem to an extended position, said cylindrical chamber having at one end an axial opening communicating with a high pressure port, said axial opening having an annular chamber with a valve seat adjacent the cylindrical chamber, a sealing poppet reciprocally mounted in said annular chamber for abutting the valve seat in an extended position, a second compression spring for urging the sealing poppet to an extended, normally-closed position against the valve seat for sealing the high pressure port, means formed in the sealing poppet for permitting the flow of fluid from the high pressure port to the annular chamber upon retraction of the poppet, said cylindrical chamber having a low pressure port in communication with the cylindrical chamber having a low pressure port in communication with the cylindrical chamber and the front side of the piston, and an atmospheric port in communication with the axial opening and with the cylindrical chamber and the rear side of the piston, whereby a decrease in low pressure fluid will axially extend the piston to open the poppet valve for communicating the high pressure port to the atmosphere.

3. A pressure-release valve comprising a valve body having a cylindrical chamber therein, said cylindrical chamber having an enlarged diameter at one end defining an enlarged co-axial chamber, said chamber having an axial opening communicating with a high pressure port at one end of the valve body, said axial opening having an annular chamber formed therein, an elongated plunger slidably mounted for reciprocal axial travel in the cylindrical chamber, the enlarged chamber and the axial opening, said plunger having cutting means at one end and an annular recess in proximity to the cutting means defining a land between the cutting means and annular recess, sealing means formed in the axial opening between the cylindrical chamber and the axial opening annular chamber for slidably receiving the plunger land in sealing engagement, a pair of opposed, spaced-apart pistons slidably mounted on the plunger concentric therewith, one of said pistons slidable in the cylindrical chamber and the other piston slidable in the enlarged chamber, detent means formed on the plunger for engaging the pistons for advancing the cutting means, means for urging the pistons axially apart, a blow-out disc closing the high pressure port, said cylindrical chamber having a low pressure port in communication with the enlarged cylindrical chamber, and an atmospheric port in communication with the annular chamber and with the cylindrical chamber between the pair of opposed pistons, whereby an increase in low pressure gas or a decrease in low pressure gas will axially extend the pistons and the plunger land to clear the axial opening sealing means to rapidly actuate the cutting means and perforate the blow-out disc to vent high pressure and low pressure gas to atmosphere.

4. A pressure-release valve comprising a valve body having a cylindrical chamber therein, said cylindrical chamber having an enlarged diameter at one end defining an enlarged co-axial chamber, said chamber having an axial opening communicating with a high pressure port at one end of the valve body, said axial opening having an annular chamber formed therein, an elongated plunger slidably mounted for reciprocal axial travel in the cylindrical chamber, the enlarged chamber and the axial opening, said plunger having a sealing poppet at one end and an annular recess in proximity to the sealing poppet defining a land between the sealing poppet and annular recess, sealing means formed in the axial opening between the cylindrical chamber and the axial opening annular chamber for slidably receiving the plunger land in sealing engagement, a pair of opposed, spaced-apart pistons slidably mounted on the plunger concentric therewith, one of said pistons slidable in the cylindrical-chamber and the other piston slidable in the enlarged chamber, detent means formed on the plunger for engaging the pistons for advancing the sealing poppet, means for urging the pistons axially apart, a valve seat adjacent the high pressure port for receiving the sealing poppet in a normally-closed position, said cylindrical chamber having a low pressure port in communication with the enlarged cylindrical chamber, and an atmospheric port in communication with the annular chamber and with the cylindrical chamber between the pair of opposed pistons, whereby an increase in low pressure gas or a decrease in low pressure gas will axially extend the pistons and the plunger land to clear the axial opening sealing means to rapidly actuate the sealing poppet clear of the valve seat to vent high pressure and low pressure gas to atmosphere.

5. A pressure-release system for use in a dual accumulator hydraulic energy storage system having a low pressure accumulator, a high-pressure accumulator and a pump/motor in fluid communication with the high pressure accumulator and the low pressure accumulator, comprising a first pressure-release valve having a high pressure gas port in communication with the high pressure accumulator and a low pressure gas port in communication with the low pressure accumulator for venting high pressure gas from the high pressure accumulator to the atmosphere when low pressure gas exceeds a predetermined high pressure, said first pressure-release valve having latching means for maintaining the valve open to continue venting of high pressure gas once venting is initiated, and a second pressure-release valve having a high pressure gas port in communication with the high pressure accumulator and a low pressure gas port in communication with the low pressure accumulator for venting high pressure gas to the atmosphere when the low pressure gas falls below a predetermined low pressure, and a check valve communicating the low pressure accumulator to the high pressure accumulator for venting low pressure gas through the high pressure port of the first valve when the high pressure gas pressure falls below the low pressure gas pressure.

6. A pressure-release system as claimed in claim 5 additionally comprising a manual valve in communication with the low pressure accumulator and the low pressure gas port of the second pressure-release valve for venting low pressure gas to atmosphere, and an orifice disposed between the low pressure accumulator and the manual valve to cause a pressure drop at the low pressure gas port of the second pressure-release valve upon opening of the manual valve and release of low pressure gas for simultaneous venting of high pressure gas to atmosphere from the second pressure-release valve.

7. A pressure-release system as claimed in claim 5 in which the first pressure-release valve is a valve as claimed in claim 1 or 3.

8. A pressure-release system as claimed in claim 5 in which the second pressure-release valve is a valve as claimed in claim 2 or 3.

9. A pressure-release system for use in a dual accumulator hydraulic energy storage system having a high pressure accumulator, a low pressure accumulator and a pump/motor in fluid communication with the high pressure accumulator by a high pressure conduit and with the low pressure accumulator by a low pressure conduit, comprising a solenoid-actuated vent valve in communication with the high pressure accumulator for controlled discharge of high pressure gas therefrom, a pressure transducer operatively connected to the low pressure conduit and to the solenoid-actuated vent valve and a pressure transducer operatively connected to the high pressure conduit and to the solenoid-actuated vent valve for sensing pressure in the low pressure and high pressure conduits for actuating the solenoid-actuated vent valve for discharging the high pressure gas to atmosphere upon sensing a fluid pressure below or above a predetermined range, and a check valve communicating the low pressure accumulator to the high pressure accumulator for venting low pressure gas from the low pressure accumulator through the solenoid-actuated vent valve when the high pressure gas falls below the low pressure gas pressure.

10. A pressure-release system for use in a compensated accumulator system having a high pressure compensated accumulator, a low pressure accumulator and a pump/motor in fluid communication with the high pressure compensated accumulator and the low pressure accumulator, comprising a vent valve in communication with the high pressure compensated accumulator for discharge of high pressure gas therefrom, said vent valve having a low pressure gas or fluid port in communication with a low pressure gas or fluid source for maintaining the first vent valve normally closed over a predetermined pressure range and sensing means operatively connected the vent valve for sensing the pressure of the low pressure gas or fluid source and actuating the vent valve for discharging the high pressure gas to atmosphere upon sensing a gas or fluid pressure below or above the predetermined range.

11. A pressure-release system as claimed in claim 10 additionally comprising a small low pressure accumulator in fluid communication with the low pressure accumulator, said small low pressure accumulator having a low pressure gas outlet in communication with the vent valve for maintaining the vent valve closed over a predetermined low pressure fluid pressure range, a first pressure-release valve in communication with the low pressure gas outlet through an orifice and with the low pressure accumulator for opening when low pressure fluid exceeds the predetermined pressure range, said first pressure-release valve having latching means for maintaining the valve open once venting is initiated, and a second pressure-release valve in communication with the low pressure gas outlet through the orifice and with the low pressure accumulator for opening when the low pressure fluid drops below the predetermined pressure range, whereby the low pressure gas pressure drops permit the vent valve to open to vent high pressure gas to atmosphere.

12. A method of releasing a compressed gas in a hydraulic energy storage system having a high pressure accumulator or compensated high pressure accumulator with a low pressure accumulator containing low pressure gas and fluid, and having sensing means in communication with the low pressure gas and fluid and operatively connected to a pressure-release valve, for controlled venting of gas to the atmosphere through the pressure-release valve, comprising sensing the pressure of the low pressure gas or fluid within a predetermined pressure range and opening the pressure-release valve upon sensing a gas or fluid pressure below or above the predetermined pressure range.
